(19) United States
(12) Patent Application Publication
(10) Pub. No.: US 2026/0341057 A1
(43) Pub. Date: Oct. 29, 2026

(54) INFORMATION PROCESSING APPARATUS AND INFORMATION PROCESSING METHOD

(71) Applicant: CANON KABUSHIKI KAISHA, Tokyo (JP)

(72) Inventor: Katsuya NAKANO, Kanagawa (JP)

(21) Appl. No.: 19/630,620

(22) Filed: Mar. 27, 2026

(30) Foreign Application Priority Data
Apr. 28, 2025 (JP) 2025-074719

(51) Int. Cl. G06V 20/70; G06F 40/58; G06V 10/40; G06V 10/774; G06V 10/82; G06V 20/62

(52) U.S. Cl. CPC G06V 20/70; G06F 40/58; G06V 10/40; G06V 10/774; G06V 10/82; G06V 20/63

(57) ABSTRACT

An information processing apparatus includes: a processor; and a memory storing a program which, when executed by the processor, causes the information processing apparatus to: execute estimation processing of estimating a language corresponding to a photographed image on a basis of information regarding a photographing scene of the photographed image; and execute generation processing of generating character information indicating features of the photographed image using, among a plurality of trained models, a trained model corresponding to the language estimated in the estimation processing.

### BACKGROUND

### Field of the Technology

The present disclosure relates to an information processing apparatus and an information processing method.

### Description of the Related Art

In recent years, a method for realizing, by a neural network, character search for an image by generating a caption that is character information indicating a summary of the image has been attracting attention. In the character search for an image, convenience is improved as the caption generation accuracy is higher, and thus, various caption generation technologies using a neural network have been devised. Japanese Patent Laid-Open No. 2020-13427 discloses a method for generating a descriptive sentence that can easily specify an object of interest by extracting an overall feature amount from an image, extracting a partial feature amount from an area of interest, and weighting it more heavily as the distance from the area of interest becomes smaller.

However, even if character information that can easily specify the object of interest can be generated from an image peculiar to a region or a culture, it is difficult to generate character information in which peculiar features of the entire image are expressed.

### SUMMARY

The present disclosure provides an information processing apparatus capable of generating, from a photographed image, character information indicating features of an image peculiar to a region or a culture.

An information processing apparatus according to the present disclosure includes: a processor; and a memory storing a program which, when executed by the processor, causes the information processing apparatus to: execute estimation processing of estimating a language corresponding to a photographed image on a basis of information regarding a photographing scene of the photographed image; and execute generation processing of generating character information indicating features of the photographed image using, among a plurality of trained models, a trained model corresponding to the language estimated in the estimation processing.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an external appearance of a digital camera.

FIG. 2 is a diagram illustrating a configuration of the digital camera.

FIG. 3 is a flowchart illustrating character information generation processing.

FIG. 4 is a flowchart of model determination processing in a position information priority mode.

FIG. 5 is a flowchart of the model determination processing in an image analysis priority mode.

FIG. 6 is a flowchart of the model determination processing in a voice analysis priority mode.

### DESCRIPTION OF THE EMBODIMENTS

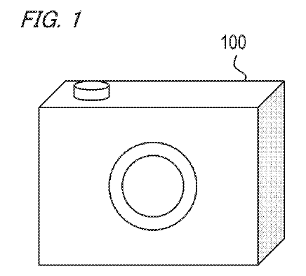

Hereinafter, an embodiment of the present disclosure will be described with reference to the drawings. FIG. 1 is a schematic diagram of an external appearance of a digital camera 100. The digital camera 100 is an example of an information processing apparatus according to the present disclosure.

The digital camera 100 can record and save a captured image in a recording medium. The digital camera 100 can generate character information in a natural language such as a caption and a prompt for a photographed image by analyzing the captured image by the generative AI. The caption and the prompt are character information indicating features of the photographed image. The digital camera 100 can automatically add descriptive information to the photographed image and automatically generate a sentence describing the features of the photographed image.

### Configuration of Digital Camera

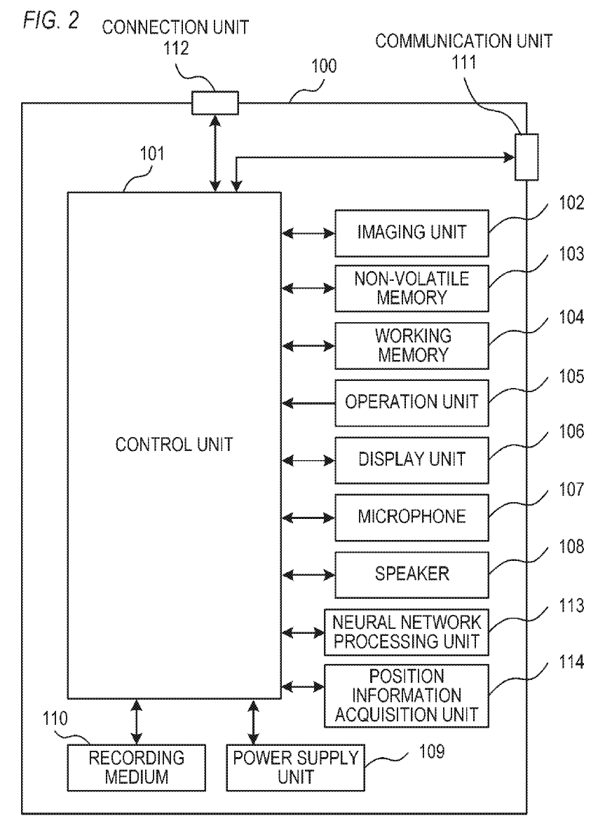

FIG. 2 is a diagram illustrating a configuration of the digital camera 100. The information processing apparatus according to the present disclosure is not limited to the digital camera 100, and may be a smartphone, a personal computer (PC), a smartwatch, a tablet terminal, or the like. Hereinafter, a case where the information processing apparatus according to the present disclosure is the digital camera 100 will be described.

A control unit 101 controls each unit of the digital camera 100 by executing processing according to an input signal or executing a program stored in a non-volatile memory 103. The control unit 101 can control the entire operation of the digital camera 100 by controlling each unit of the digital camera 100. The control unit 101 controls communication with an external device in cooperation with a communication unit 111. The control unit 101 can also execute specific processing on the cloud by communicating with an external device.

Furthermore, the control unit 101 determines a model to be used for generating character information indicating features of a photographed image among a plurality of trained models recorded in the non-volatile memory 103 and a recording medium 110. The trained model to be used for generating the character information is a model for receiving the photographed image as input and outputting the character information, and is a model trained using a training image and training character information indicating features of the training image in a language corresponding to the trained model. The trained model can generate the character information in a predetermined language used at the time of training. The predetermined language may be one specific language or a plurality of languages. The trained model may be a neural network model or a model trained on the basis of other various machine learning algorithms.

Note that the control unit 101 may control the entire operation of the digital camera 100 by executing a part of the processing by a plurality of hardware circuits instead of executing the program and controlling the entire operation of the digital camera 100.

The imaging unit 102 includes an optical system, an imaging element, and the like. The optical system includes, for example, an optical lens unit and a control mechanism such as a diaphragm, a zoom, and a focus. The imaging element converts light (video) introduced through the optical lens unit into an electrical video signal. The imaging unit 102 converts subject light focused by a lens included in the optical lens unit into an electrical signal by the imaging element, and outputs digital data subjected to noise reduction processing or the like as image data or moving image data. The imaging unit 102 includes a shutter capable of freely controlling an exposure time of the imaging element.

The non-volatile memory 103 is an electrically erasable and recordable non-volatile memory. The non-volatile memory 103 stores, for example, a program executed by the control unit 101 and a plurality of neural network models. The neural network model may be, for example, a neural network model corresponding to multi-modal processing using two types of data, voice and images, as inputs, or may be a neural network model corresponding to single-modal processing using only images as inputs.

A working memory 104 is used as, for example, a buffer memory that temporarily holds image data and moving image data captured by the imaging unit 102, an image display memory of a display unit 106, and a work area of the control unit 101. In addition, the working memory 104 is used as a temporary storage area when a neural network processing unit 113 performs a neural network operation.

An operation unit 105 is a user interface (UI) for receiving an instruction from a user to the digital camera 100. The operation unit 105 includes, for example, a power switch for the user to instruct on/off of the power of the digital camera 100, a release switch for instructing photographing, a reproduction button for instructing reproduction of image data, and the like. The operation unit 105 may include a touch panel formed on the display unit 106.

The release switch includes a switch SW1 and a switch SW2. The switch SW1 is turned on when the release switch is half-pressed. When the switch SW1 is turned on, the release switch receives a preparation instruction for performing an imaging preparation operation such as autofocus (AF) processing, automatic exposure (AE) processing, automatic white balance (AWB) processing, and flash preliminary emission (EF) processing. The switch SW2 is turned on when the release switch is fully pressed. When the switch SW2 is turned on, the release switch receives an imaging instruction for performing an imaging operation.

The display unit 106 displays a viewfinder image at the time of photographing, photographed image data, and character information for an interactive operation. When displaying character information in a natural language, the display unit 106 displays the character information in a language of a preset type among a plurality of language types. The display unit 106 may be an external display device connected to the digital camera 100 without being built into the digital camera 100. The digital camera 100 only needs to have a display control function of controlling the display on the built-in display unit 106 or the externally connected display unit 106.

A microphone 107 is a microphone used to input sound waves such as sound and voice to the digital camera 100. Microphone 107 converts sound and voice into electrical signals and inputs the electrical signals to the digital camera 100. The control unit 101 generates voice data from the input electrical signals. For example, the control unit 101 can synchronously record the generated voice data and the moving image data photographed by the imaging unit 102. The control unit 101 can record the voice data in association with the image data photographed by the imaging unit 102.

The microphone 107 may be attachable and detachable with respect to the digital camera 100 or may be built into the digital camera 100. The digital camera 100 only needs to be able to receive an electrical signal from the microphone 107. When connected to a wireless microphone (not illustrated) via the communication unit 111, the digital camera 100 can record a voice input from the wireless microphone in synchronization with the photographed moving image data without using a voice input from the microphone 107.

A speaker 108 is an electroacoustic transducer capable of outputting an electronic sound. The control unit 101 can convert voice data recorded in the non-volatile memory 103 into a voice signal and output the converted voice signal through the speaker 108.

A power supply unit 109 supplies power to each unit of the digital camera 100. The power supply unit 109 is, for example, a power supply such as a lithium-ion battery or an alkaline manganese dry battery.

The recording medium 110 can record image data output from the imaging unit 102. The recording medium 110 is, for example, an SD card or a CF card. The recording medium 110 may be attachable and detachable with respect to the digital camera 100 or may be built into the digital camera 100. The digital camera 100 only needs to be able to access the recording medium 110.

The communication unit 111 is a communication interface for wirelessly connecting to an external device. The digital camera 100 exchanges data with an external device via the communication unit 111. For example, the control unit 101 can transmit image data generated by the imaging unit 102 and voice data recorded in the non-volatile memory 103 to an external device via the communication unit 111. Examples of the external device include, for example, an electronic device such as a smartphone or a PC, an external speaker such as an earphone or a headphone, and a strobe. Note that the communication unit 111 may include an interface for communicating with an external device in accordance with the Bluetooth (trademark) standard.

A connection unit 112 is a communication interface for wired connection with an external device. The digital camera 100 exchanges data with an external device via the connection unit 112. For example, the control unit 101 can transmit image data generated by the imaging unit 102 and moving image data recorded in the non-volatile memory 103 to an external device via the connection unit 112. Furthermore, the control unit 101 can receive a voice signal and voice data from an external device such as an external microphone via the connection unit 112.

The neural network processing unit 113 is a processing unit for exclusively performing AI processing using a neural network. The neural network processing unit 113, by using a photographed image as an input, performs AI processing for generating a prompt that is character information for generating an image obtained by reproducing the photographed image and a caption that is character information for describing the photographed image.

A position information acquisition unit 114 acquires current position information of the digital camera 100. The position information acquisition unit 114 can acquire position information of the digital camera 100 using a Global Positioning System (GPS). The position information acquisition unit 114 is not limited to the case of using the GPS and can acquire the current position by communicating with an external device via the communication unit 111.

### Character Information Generation Processing

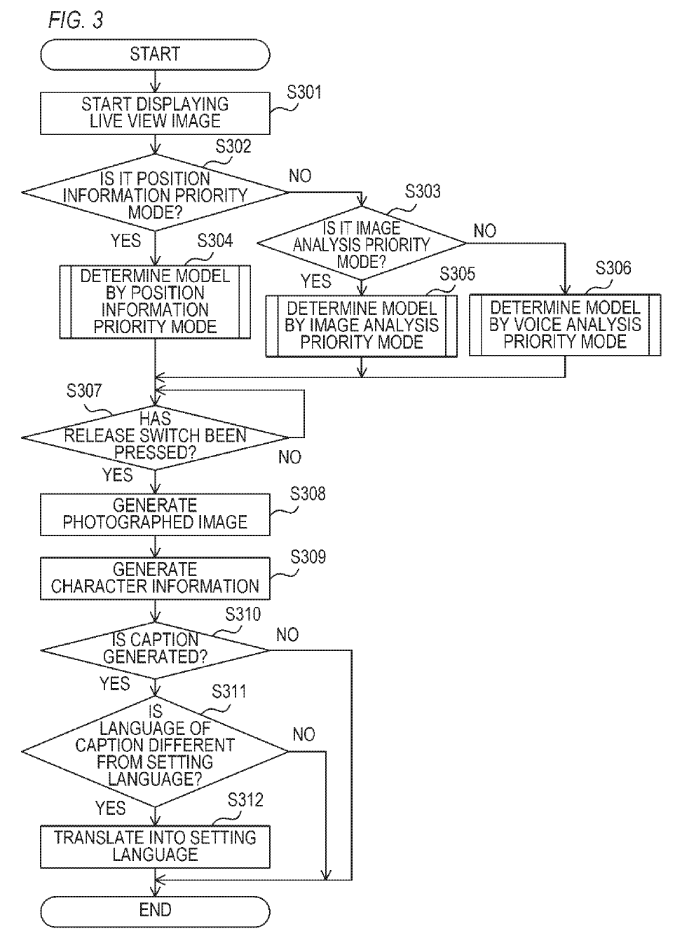

The character information generation processing will be described with reference to FIG. 3. The character information includes a prompt that is information for generating an image obtained by reproducing a photographed image and a caption that is information for describing the photographed image. The digital camera 100 can generate character information by inputting a captured image generated by the imaging unit 102 to a trained model that is a neural network model. Hereinafter, a case where the control unit 101 uses a generative AI model as the trained model will be described. The character information generation processing illustrated in FIG. 3 is started when the user turns on the power of the digital camera 100 by the operation unit 105.

In step S301, the imaging unit 102 starts displaying a live view image in accordance with an instruction from the control unit 101. The imaging unit 102 displays the live view image on the display unit 106 until the user presses the release switch of the operation unit 105 and the imaging operation begins.

In step S302, the control unit 101 determines, among a plurality of generative AI models, whether or not a model determination mode for determining a generative AI model to be used for generating character information is set to a position information priority mode. The position information priority mode is a mode for prioritizing position information of the digital camera 100 and determining a generative AI model to be used for generating character information. In a case where the model determination mode is set to a position information priority mode (step S302: YES), the processing proceeds to step S304. In a case where the model determination mode is not set to a position information priority mode (step S302: NO), the processing proceeds to step S303.

In step S303, the control unit 101 determines whether or not the model determination mode is set to an image analysis priority mode. The image analysis priority mode is a mode for prioritizing a result of image analysis of the live view image and determining a generative AI model to be used for generating character information. In a case where the model determination mode is set to an image analysis priority mode (step S303: YES), the processing proceeds to step S305. In a case where the model determination mode is not set to an image analysis priority mode (step S303: NO), the processing proceeds to step S306.

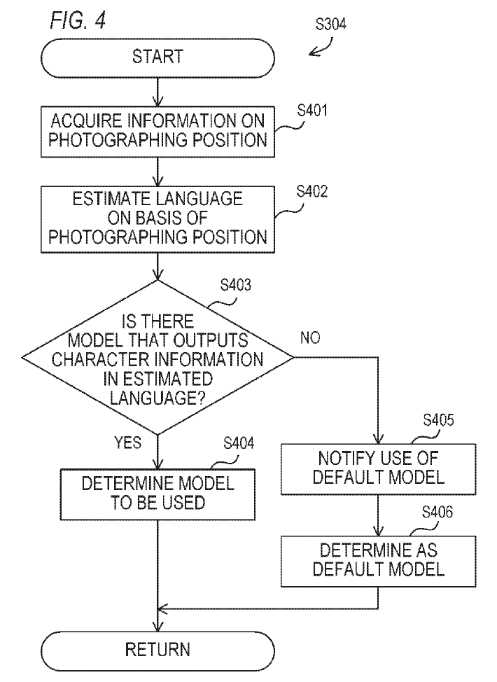

In step S304, the control unit 101 determines the generative AI model to be used for generating the character information on the basis of the position information of the digital camera 100. Details of the processing in step S304 will be described later with reference to FIG. 4.

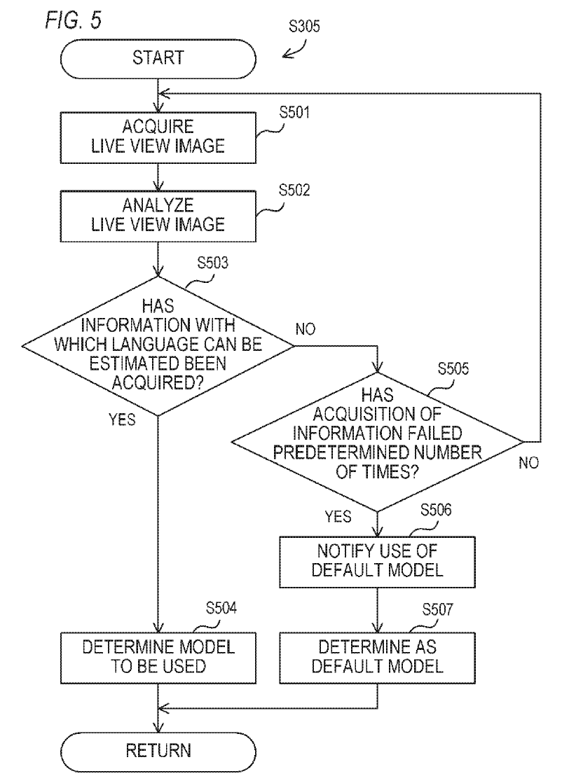

In step S305, the control unit 101 determines the generative AI model to be used for generating the character information on the basis of the result of the image analysis of the live view image. Details of the processing in step S305 will be described later with reference to FIG. 5.

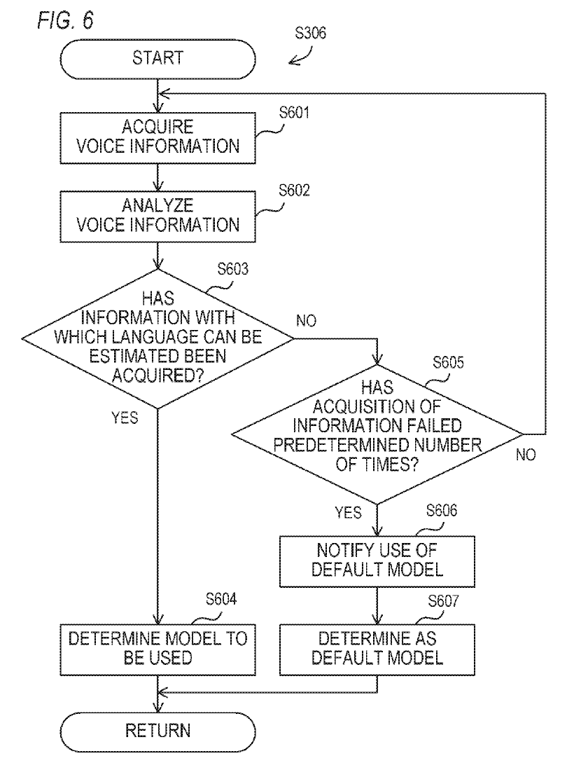

In step S306, the control unit 101 determines the generative AI model to be used for generating the character information on the basis of the analysis result of the voice collected from the microphone 107. The model determination mode for determining the generative AI model by prioritizing the analysis result of the voice is referred to as a voice analysis priority mode. Details of the processing in step S306 will be described later with reference to FIG. 6.

In steps S304 to S306, the control unit 101 estimates a language corresponding to the photographed image on the basis of information regarding a photographing scene of the photographed image. The information regarding the photographing scene includes, for example, information on a photographing position, information indicating characters and regional features included in a photographing range, and information on words whose sound is collected in the photographing scene. The control unit 101 determines, among a plurality of generative AI models, a generative AI model corresponding to the estimated language as the generative AI model to be used for generating the character information.

In step S307, the control unit 101 determines whether or not the user has pressed (fully pressed) the release switch of the operation unit 105. In a case where it is determined that the user has pressed the release switch (step S307: YES), the processing proceeds to step S308. In a case where it is determined that the user has not pressed the release switch (step S307: NO), the processing of step S307 is repeated. That is, the control unit 101 continues the display of the live view image and waits until the release switch is pressed. In step S308, the imaging unit 102 executes imaging processing to generate a photographed image in accordance with an instruction from the control unit 101.

In step S309, the control unit 101 transmits the photographed image generated in step S308 to the neural network processing unit 113. The neural network processing unit 113 generates character information indicating features of the photographed image using the generative AI model determined in steps S304 to S306.

The generative AI model outputs a caption or a prompt indicating the features of the photographed image. The generative AI model trained to output captions outputs a caption, and the generative AI model trained to output prompts outputs a prompt. The caption is information on a descriptive sentence for the photographed image. The caption can make the user understand what kind of image the photographed image is, by using a natural language.

The prompt is instruction information for generating an image by a generative AI model trained to generate an image on the basis of input character information, and is described using a natural language. The generative AI model can generate an image by performing AI processing on the input prompt. The prompt generated in step S309 is instruction information for reproducing an image imitating the photographed image by the generative AI model. A type of the language of the character information to be generated is determined by the generative AI model to be used.

In step S310, the control unit 101 determines whether or not a caption has been generated as the character information in step S309. In a case where a caption has been generated (step S310: YES), the processing proceeds to step S311. In a case where a prompt instead of a caption has been generated (step S310: NO), it is determined that the generation of the character information has been completed, and the processing illustrated in FIG. 3 ends.

In step S311, the control unit 101 determines whether or not a language type of the caption generated in step S309 is different from a language type of a setting language. The setting language is a language used for display on the display unit 106, and is a language set by the user in advance for the digital camera 100. In a case where the language type of the caption is different from the language type of the setting language (step S311: YES), the processing proceeds to step S312. In a case where the language type of the caption is the same as the language type of the setting language (step S311: NO), it is determined that generation of the character information has been completed, and the processing illustrated in FIG. 3 ends.

In step S312, the control unit 101 translates (converts) the caption generated in step S309 into a setting language set in advance by the user. The setting language is a language used for display on the display unit 106 and is a language that can be easily interpreted by the user. The control unit 101 does not display the generated caption in the language as it is but displays the generated caption after translating the generated caption into the setting language that can be easily interpreted by the user. The control unit 101 generates character information indicating features of the photographed image using an optimal generative AI model in a language corresponding to the generative AI model and translates the character information into the setting language set by the user. Therefore, the user can refer to the caption of the photographed image in a familiar language.

On the other hand, a prompt is not character information referred to by the user but is character information mainly used by the generative AI model to generate an image. Therefore, the control unit 101 does not translate (convert) the prompt generated in step S309 into the setting language but uses the prompt for image generation. By generating an image by using the prompt generated by the generative AI model as it is without translation, the control unit 101 can suppress a decrease in reproduction accuracy of the photographed image.

Note that the control unit 101 can also translate (convert) the prompt generated in step S309 into the setting language for use. That is, the control unit 101 may translate the character information into the setting language in a case where the language type of the character information is different from the language type of the setting language without executing the determination in step S310. In a case where the prompt is translated into the setting language, the user can easily understand and correct the prompt.

In the processing illustrated in FIG. 3, the digital camera 100 determines the generative AI model to be used on the basis of the photographing position, the photographed image, the voice information, and the like. Since, among a plurality of generative AI models, an appropriate generative AI model is selected and used, the scale of each generative AI model can be suppressed.

The digital camera 100 can suppress a decrease in accuracy of character information to be generated while using the generative AI model with a reduced scale. In a case where a caption is generated, the digital camera 100 translates (converts) the generated character information into the setting language set by the user. The digital camera 100 can appropriately generate a caption that is descriptive information of the photographed image to be presented to the user and a prompt for generating an image obtained by reproducing the photographed image.

Details of a model determination procedure in a position information priority mode will be described with reference to FIG. 4. The processing illustrated in FIG. 4 is details of the processing of step S304 in FIG. 3. In step S401, the position information acquisition unit 114 acquires information on a current photographing position in accordance with an instruction from the control unit 101.

In step S402, the control unit 101 estimates a language corresponding to the photographed image on the basis of the information on the photographing position acquired in step S401. The control unit 101 can estimate a language spoken at the current photographing position from correspondence information between a position and a language stored in the non-volatile memory 103. The correspondence information between the position and the language is, for example, information indicating a correspondence relationship between a region specified by latitude and longitude and a language spoken in the region. The control unit 101 can estimate the language corresponding to the region including the latitude and longitude indicating the current photographing position as the language spoken at the current photographing position on the basis of the correspondence information between the position and the language.

In step S403, the control unit 101 determines whether or not there is a model that outputs character information in the language estimated in step S402 among one or more pieces of generative AI model information stored in the non-volatile memory 103. In a case where there is a model that outputs character information in the estimated language (step S403: YES), the processing proceeds to step S404. In a case where there is no model that outputs character information in the estimated language (step S403: NO), the processing proceeds to step S405.

In step S404, the control unit 101 determines one generative AI model to be used among the generative AI models that output character information in the language estimated in step S402. In a case where there is a plurality of candidate generative AI models, the control unit 101 selects, for example, a generative AI model trained using a training image photographed in a predetermined region including the current photographing position. The predetermined region is, for example, a region and a country where the same language is spoken, a region where the same dialect is spoken, a region with a cultural connection, or the like. The generative AI model can be recorded in the non-volatile memory 103 in advance in association with information on the predetermined region where the training image used for training is photographed.

Note that a priority order may be set in advance for the plurality of generative AI models. The control unit 101 can determine the generative AI model to be used, by combining conditions such as the photographing position and the priority order of the generative AI model.

Furthermore, in a case where the generative AI model determined in step S404 is a model trained using a plurality of languages, the control unit 101 generates character information in, among the plurality of languages, a language estimated on the basis of information on the current photographing position in step S309. The control unit 101 can generate the character information in the language by designating the language estimated on the basis of the information on the current photographing position for the generative AI model.

In step S405, the control unit 101 displays, on the display unit 106, a notification notifying the user that there is no model that outputs character information in the estimated language and that a default model is to be used. In step S406, the control unit 101 determines the generative AI model to be used as a default model, which is a general-purpose generative AI model.

In the position information priority mode described in FIG. 4, the digital camera 100 determines the generative AI model to be used on the basis of the information on the current photographing position. The digital camera 100 can use a generative AI model trained using a training image related to the current photographing position. Therefore, the digital camera 100 can generate character information appropriately expressing regional features of the photographed image.

Details of a model determination procedure in an image analysis priority mode will be described with reference to FIG. 5. The processing illustrated in FIG. 5 is details of the processing of step S305 in FIG. 3. In step S501, the imaging unit 102 acquires a live view image in accordance with an instruction from the control unit 101.

In step S502, the control unit 101 analyzes the live view image acquired in step S501. The control unit 101 acquires information indicating characters and regional features included in a photographing range by image analysis of the live view image. The regional features are, for example, a building, a festival, a plant, an animal, a costume, or the like peculiar to the region. Information on the correspondence relationship between the regional features and the languages is stored in advance in the non-volatile memory 103. The control unit 101 can estimate the language corresponding to the photographed image on the basis of the information acquired by the image analysis.

For example, the control unit 101 can estimate the language corresponding to the photographed image from characters described on a signboard or a poster appearing in the live view image. Furthermore, the control unit 101 can also estimate the language corresponding to the photographed image from the regional features of the live view image by using a neural network model trained to receive an image indicating the regional features as input and output information on the corresponding region and language.

In step S503, the control unit 101 determines whether or not information (characters or regional features) with which the language corresponding to the live view image can be estimated has been acquired by the image analysis of the live view image in step S502. In a case where the information with which the language corresponding to the live view image can be estimated has been acquired (step S503: YES), the processing proceeds to step S504. In a case where the information with which the language corresponding to the live view image can be estimated has not been acquired (step S503: NO), the processing proceeds to step S505.

In step S504, the control unit 101 determines one generative AI model to be used for outputting the character information. The control unit 101 estimates the language corresponding to the photographed image on the basis of the information acquired by the image analysis of the live view image in step S503. The control unit 101 determines the generative AI model to be used by executing processing similar to steps S403 and S404 in FIG. 4 for the estimated language.

Note that each of the plurality of generative AI models may be recorded in the non-volatile memory 103 in advance in association with regional features. The generative AI model is associated with, for example, regional features included in the training image used for training. The control unit 101 can determine, among a plurality of generative AI models, the generative AI model corresponding to the regional features obtained by analyzing the live view image as the generative AI model to be used for generating the character information.

Furthermore, in a case where the generative AI model determined in step S504 is a model trained using a plurality of languages, the control unit 101, in step S309, generates character information in a language estimated on the basis of information indicating characters and regional features included in the photographing range. The control unit 101 can generate character information in a language estimated on the basis of information indicating characters and regional features included in the photographing range by designating the language for the generative AI model. Note that the generative AI model may be trained to estimate a corresponding language on the basis of information indicating characters and regional features included in the input photographed image and generate character information in the estimated language. In this case, the control unit 101 can generate character information in the language corresponding to the photographed image by inputting the photographed image into the generative AI model without designating the language.

In step S505, the control unit 101 determines whether or not the acquisition of the information with which the language corresponding to the live view image can be estimated has failed a predetermined number of times. In a case where the acquisition of the information with which the language can be estimated has failed a predetermined number of times (step S505: YES), the processing proceeds to step S506. In a case where the acquisition of the information with which the language can be estimated has not failed a predetermined number of times or more (step S505: NO), the processing returns to step S501. Upon returning to step S501, the control unit 101 newly acquires a live view image and continues the subsequent processing.

In step S506, the control unit 101 displays, on the display unit 106, a notification notifying the user that there is no model that outputs character information in the estimated language and that a default model is to be used. In step S507, the control unit 101 determines the generative AI model to be used for generating the character information as a default model that is a general-purpose generative AI model.

In the image analysis priority mode described with reference to FIG. 5, the digital camera 100 determines a generative AI model to be used on the basis of information indicating characters and regional features acquired by analysis of a live view image. The digital camera 100 can use a generative AI model trained using a training image related to characters and regional features recognized in a photographing scene. Therefore, the digital camera 100 can generate character information appropriately expressing the regional features of the photographed image.

Details of a model determination procedure in a voice analysis priority mode will be described with reference to FIG. 6. The processing shown in FIG. 6 is details of the processing of step S306 in FIG. 3. In step S601, the control unit 101 acquires external voice information collected by the microphone 107.

In step S602, the control unit 101 analyzes the voice information acquired in step S601. By analyzing the voice information, the control unit 101 acquires information on words whose sound is collected in a photographing scene. The control unit 101 can estimate the language corresponding to the photographed image on the basis of the information acquired by the analysis of the voice information. For example, the control unit 101 can estimate a language corresponding to a photographed image from words, conversations, and the like recognized from voice collected by the microphone 107. In addition, the control unit 101 can estimate the language corresponding to the photographed image from the voice information collected by the microphone 107 using a neural network model trained to receive voice as input and output information on the corresponding region and language.

In step S603, the control unit 101 determines whether or not information (words or the like) with which the language corresponding to the photographing scene can be estimated has been acquired by analyzing the voice information in step S602. In a case where the information with which the language corresponding to the photographing scene can be estimated has been acquired (step S603: YES), the processing proceeds to step S604. In a case where the information with which the language corresponding to the photographing scene can be estimated has not been acquired (step S603: NO), the processing proceeds to step S605.

In step S604, the control unit 101 determines one generative AI model to be used for outputting character information. The control unit 101 estimates a language corresponding to the photographed image on the basis of the information acquired by the analysis of the voice information in step S603. The control unit 101 determines the generative AI model to be used by executing processing similar to steps S403 and S404 in FIG. 4 for the estimated language.

Note that each of the plurality of generative AI models may be recorded in the non-volatile memory 103 in advance in association with a photographing scene recognized from words, conversations, and the like. The control unit 101 can determine, among the plurality of generative AI models, as the generative AI model to be used for generating character information, a generative AI model corresponding to the photographing scene recognized from the words, the conversations, and the like acquired by the analysis of the voice information.

Furthermore, in a case where the generative AI model determined in step S604 is a model trained using a plurality of languages, in step S309, the control unit 101 generates character information in a language estimated on the basis of information on words whose sound is collected in the photographing scene. The control unit 101 can generate character information in the language estimated on the basis of the information on the words whose sound is collected in the photographing scene by designating the language for the generative AI model.

In step S605, the control unit 101 determines whether or not the acquisition of the information with which the language corresponding to the photographing scene can be estimated has failed a predetermined number of times. In a case where the acquisition of the information with which the language can be estimated has failed a predetermined number of times (step S605: YES), the processing proceeds to step S606. In a case where the acquisition of the information with which the language can be estimated has not failed a predetermined number of times or more (step S605: NO), the processing returns to step S601. Upon returning to step S601, the control unit 101 newly acquires a live view image and continues the subsequent processing.

In step S606, the control unit 101 displays, on the display unit 106, a notification notifying the user that there is no model that outputs character information in the estimated language and that a default model is to be used. In step S607, the control unit 101 determines the generative AI model to be used for generating character information as a default model that is a general-purpose generative AI model.

In the voice analysis priority mode described with reference to FIG. 6, the digital camera 100 determines the generative AI model to be used on the basis of information such as words acquired by analysis of external voice information. The digital camera 100 can use a generative AI model trained using a training image related to a photographing scene recognized from words, conversations, and the like acquired by analysis of voice information. Therefore, the digital camera 100 can generate character information appropriately expressing the photographing scene of the photographed image.

In the above embodiment, the digital camera 100 generates character information indicating features of the photographed image using, among a plurality of trained models, a trained model corresponding to a language estimated on the basis of information regarding a photographing scene of the photographed image. Even if one trained model corresponding to various languages is not prepared, the digital camera 100 can select an appropriate model according to the photographing scene from the plurality of trained models and generate character information. Therefore, the scale of each trained model can be made smaller. Furthermore, by using a trained model trained by using a training image according to a language and regional features, the digital camera 100 can generate character information appropriately reflecting culture, custom, and the like according to the region.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to provide an information processing apparatus capable of generating character information indicating features of an image peculiar to a region or a culture from a photographed image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-074719, filed Apr. 28, 2025, which is hereby incorporated by reference herein in its entirety.

What is claimed is:

1. An information processing apparatus comprising:
a processor; and
a memory storing a program which, when executed by the processor, causes the information processing apparatus to:
execute estimation processing of estimating a language corresponding to a photographed image on a basis of information regarding a photographing scene of the photographed image; and
execute generation processing of generating character information indicating features of the photographed image using, among a plurality of trained models, a trained model corresponding to the language estimated in the estimation processing.

2. The information processing apparatus according to claim 1, wherein
the trained model is a model for receiving the photographed image as input and outputting the character information, and is a model trained using a training image and training character information indicating features of the training image in a language corresponding to the trained model.

3. The information processing apparatus according to claim 2, wherein
the trained model is a model trained using the training image photographed in a predetermined region.

4. The information processing apparatus according to claim 1, wherein
in the generation processing, in a case where the trained model is a model trained using a plurality of languages, the character information is generated in, among the plurality of languages, a language estimated on a basis of the information regarding the photographing scene.

5. The information processing apparatus according to claim 1, wherein
the information regarding the photographing scene includes information on a photographing position.

6. The information processing apparatus according to claim 1, wherein
the information regarding the photographing scene includes information indicating characters and regional features included in a photographing range.

7. The information processing apparatus according to claim 1, wherein
the information regarding the photographing scene includes information on words whose sound is collected in the photographing scene.

8. The information processing apparatus according to claim 1, wherein
the character information is a prompt that is information for generating an image obtained by reproducing the photographed image or a caption that is information for describing the photographed image.

9. The information processing apparatus according to claim 8, wherein
in the generation processing, in a case where a language type of the character information generated using the trained model is different from a language type of a setting language set in advance by a user,
if the character information is the prompt, the prompt is not converted into the setting language, and
if the character information is the caption, the caption is converted into the setting language.

10. The information processing apparatus according to claim 1, wherein
in the generation processing, in a case where a language type of the character information generated using the trained model is different from a language type of a setting language set in advance by a user, the character information is converted into a setting language set by the user.

11. An information processing method comprising;
estimating a language corresponding to a photographed image on a basis of information regarding a photographing scene of the photographed image; and
generating character information indicating features of the photographed image using, among a plurality of trained models, a trained model corresponding to the language estimated in the estimation processing.

12. A non-transitory computer readable medium that stores a program, wherein the program causes a computer to execute an information processing method comprising:
estimating a language corresponding to a photographed image on a basis of information regarding a photographing scene of the photographed image; and
generating character information indicating features of the photographed image using, among a plurality of trained models, a trained model corresponding to the language estimated in the estimation processing.
